(19) United States
(12) Patent Application Publication
(10) Pub. No.: US 2011/0257938 A1
(43) Pub. Date: Oct. 20, 2011

(54) SYSTEM AND METHOD FOR USE IN DESIGNING AIR INTAKES

(76) Inventors: William Eyers, Chobham (GB); Scott Stubbington, Waterlooville (GB); Gordon Ayshford, Godalming (GB); Peter Smith, Basingstoke (GB); David Bartram, Totton (GB)

(21) Appl. No.: 12/761,855

(22) Filed: Apr. 16, 2010

(51) Int. Cl. G06F 17/50; G06N 5/00

(52) U.S. Cl. 703/1; 706/45

(57) ABSTRACT

A method for designing an air intake apparatus. The method includes receiving an indication of a requirement. A number of structural members to be used in the air intake and, optionally, one or more dimensions corresponding to the structural members are determined based at least in part on the requirement. A three-dimensional model of an air intake is generated based at least in part on the plurality of structural members and presented. One or more two-dimensional models may be generated based on the three-dimensional model and may further be output as manufacturing diagrams.

### BACKGROUND OF THE INVENTION

The subject matter disclosed herein relates generally to air intakes and, more specifically, to systems and methods for use in designing an intake system for a combustion engine.

At least some known air intake systems (e.g., turbine engines and/or ventilation systems) include an intake filter house that houses a filter assembly used to remove moisture and particulate matter, such as dust and/or debris, from air entering the air intake system and, more specifically, air channeled to a fan and/or a compressor. Some known intake filter houses also include an intake cooler, such as an evaporative cooler, and/or a transition unit, which functions as an interface with one or more intake ducts and/or one or more vent ducts.

Optimal intake filter house design facilitates optimal and efficient operation of an air intake system. However, like any structure or component, an intake filter house must be constructed in accordance with applicable regulations, such as building standards and/or building codes. Ad hoc design of intake filter houses generally imposes significant costs by encouraging the use of custom structural components designed to satisfy the requirements of each site. Moreover, depending on the number of building codes and/or restrictions, and the design factors necessary to ensure the air intake system is capable of meeting operating requirements, designing an intake filter house may be a time-consuming and tedious task. Accordingly, it is desirable to provide an automated method for designing an intake system that facilitates the use of standardized components according to applicable building standards.

### BRIEF DESCRIPTION OF THE INVENTION

In one aspect, a system for use in designing an air intake apparatus is provided. The system includes an input interface configured to receive an indication of a building standard and an indication of a structural feature. The building standard defines at least one structural requirement. The system also includes a processor coupled to the input interface and programmed to determine, based at least in part on the building standard, a number of structural members to be used in an air intake. The processor is also programmed to generate a three-dimensional model of the air intake based at least in part on the structural members determined and the indicated structural feature. The system further includes a presentation interface coupled to the processor and configured to output the three-dimensional model to a user.

In another aspect, a method is provided for use in designing an air intake apparatus. The method includes receiving, via an input interface, an indication of at least one requirement including a load requirement, a deflection requirement, a dimensional attribute, and/or a ventilation requirement. A number of structural members to be used in an air intake is determined by a processor based at least in part on the building standard. A three-dimensional model of the air intake including the plurality of structural members is generated by the processor. The three-dimensional model is presented via a presentation interface.

### BRIEF DESCRIPTION OF THE DRAWINGS

FIG. 1 is a block diagram of an exemplary computing device;

FIG. 2 is a block diagram of an exemplary design network including a knowledge base system, a knowledge base management system, and an intake design system coupled in communication via a network;

FIG. 3 is a flowchart of an exemplary method for use in designing an air intake;

FIG. 4 is an exemplary graphical interface that may be used with the intake design system shown in FIG. 2;

FIG. 5 is a schematic view of an exemplary filter module stack including a plurality of filter modules designed using the method shown in FIG. 3;

FIG. 6 is a schematic view of an exemplary filter module stack assembly including the filter module stack shown in FIG. 5;

FIG. 7 is an offset schematic view of the filter module stack shown in FIG. 5; and

FIG. 8 is a schematic view of an exemplary air intake including the filter module stack assembly shown in FIG. 6.

### DETAILED DESCRIPTION OF THE INVENTION

The embodiments described herein facilitate designing an air intake apparatus for a system such as, without limitation, a combustion engine (e.g., a gas turbine engine or a four-stroke engine, such as a diesel engine) or a heating/ventilation/air conditioning (HVAC) system. Using the described embodiments, one may design an air intake in an automated computer system, based on one or more building standards. Such building standards may include, but are not limited to including, the Uniform Building Code (UBC), the International Building Code (IBC), national building codes, local building codes, voluntarily adopted building standards, and/or any other standard defining structural requirements applicable to an air intake for a ground-based air intake system.

As used herein, the term “structural requirement” includes any of loading requirements (e.g., snow loading and/or wind loading), deflection requirements, ventilation requirements (e.g., an airflow requirement), requirements regarding a quantity, a position, and/or dimensions of means of egress, and/or any other specification of a physical attribute and/or physical performance of an air intake. Such physical attributes may include, without limitation, one or more dimensional parameters, which may specify, for example, a minimum and/or a maximum dimensional attribute for at least a portion of an air intake.

Embodiments are described herein with reference to air intakes used with ground-based air intake systems, which may include, but are not limited to, combustion engines and HVAC systems. An air intake includes, without limitation, an intake filter house, an intake cooler, one or more intake ducts and/or vent ducts (e.g., including silencing bleeding, a heating device, etc.), and/or a transition unit. A transition unit may include, for example, an interface between vent ducting and intake ducting that leads to a compressor, a combustion chamber, and/or a fan.

Moreover, an air intake system is fabricated, at least in part, with structural members that bear a load, whether static or dynamic. For example, such structural members may include frame components, intake filter modules, walls, mounting devices, and/or stairs. Moreover, structural features may include any physical attribute that affects the structure of an air intake. For example, such structural features may include, without limitation, a type of intake filter (e.g., a static filter and/or pulse filter), a quantity of intake filters, a type of intake cooler (e.g., an evaporative cooler and/or a vapor compression cooler), and/or optional components, such as a gantry crane, a floor drain, an access hatch, and/or a structural member stiffener. Multiple structural members, structural features, and/or other physical components may be combined into an assembly. Furthermore, a structural member, a structural feature, a physical component, and/or an assembly may be associated with one or more physical attributes, including dimensional attributes. For example, a structural member may be associated with a width, a height, and/or a depth.

An exemplary technical effect of the methods, systems, and apparatus described herein includes at least one of (a) receiving an indication of a building standard defining at least one structural requirement that is associated with a load requirement and/or a deflection requirement; (b) determining, by a processor, based at least in part on the building standard, a number of structural members; and (c) generating a three-dimensional model of an air intake, wherein the three-dimensional model includes the structural members.

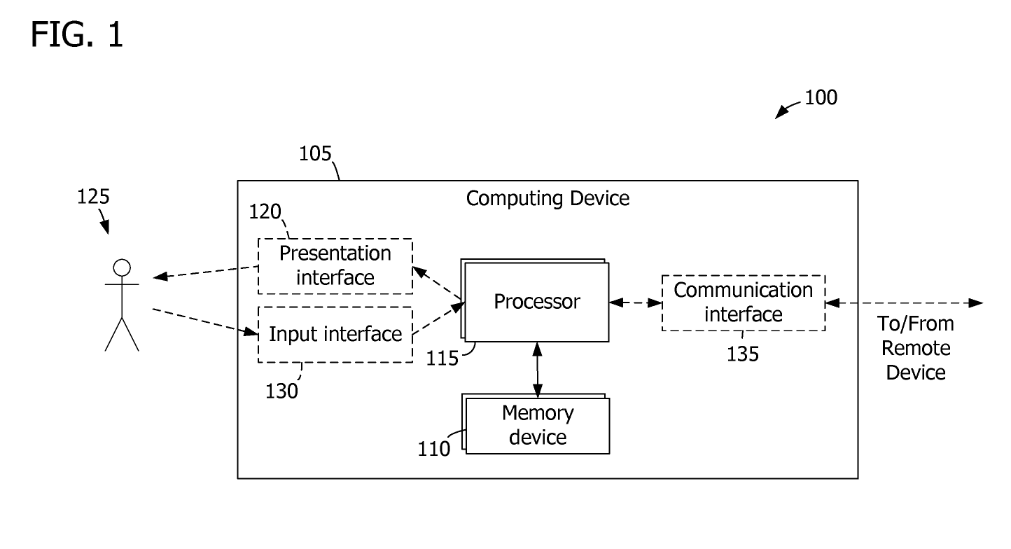

FIG. 1 is a block diagram of an exemplary design system 100 with a computing device 105 that includes a memory device 110 and that may be used to design an air intake. Computing device 105 includes a processor 115 coupled to memory device 110 for executing programmed instructions. In some embodiments, executable instructions are stored in memory device 110. Computing device 105 is programmable to perform one or more operations described herein by programming processor 115. For example, processor 115 may be programmed by encoding an operation as one or more executable instructions and providing the executable instructions in memory device 110. Processor 115 may include one or more processing units (e.g., in a multi-core configuration).

Processor 115 may include, but is not limited to, a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. The methods described herein may be encoded as executable instructions embodied in a computer readable medium, including, without limitation, a storage device and/or a memory device. Such instructions, when executed by a processor, cause the processor to perform at least a portion of the methods described herein. The above examples are exemplary only, and thus are not intended to limit in any way the definition and/or meaning of the term processor.

Memory device 110 is one or more devices allowing information such as executable instructions and/or other data to be stored and retrieved. Memory device 110 may include one or more computer readable media, such as, without limitation, dynamic random access memory (DRAM), static random access memory (SRAM), a solid state disk, and/or a hard disk. Memory device 110 may be configured to store, without limitation, executable instructions, configuration data, building standard data, site attribute data, structural feature data, air intake assembly data, air intake model data, and/or any other type of data.

In the exemplary embodiment, computing device 105 includes a presentation interface 120 coupled to processor 115. Presentation interface 120 is configured to output (e.g., display, print, and/or otherwise output) information, such as, but not limited to, building standard data, air intake system assembly data, and/or a model of an air intake, to a user 125. For example, presentation interface 120 may include a display adapter (not shown in FIG. 1) that is coupled to a display device, such as a cathode ray tube (CRT), a liquid crystal display (LCD), an organic LED (OLED) display, and/or an “electronic ink” display. In some embodiments, presentation interface 120 includes more than one display device. In addition to, or in the alternative, presentation interface 120 may include a printer.

In some embodiments, computing device 105 includes an input interface 130 that receives input from user 125. For example, input interface 130 may be configured to receive an indication of a building standard, a dimensional parameter, a site attribute, a structural feature, a predefined structural member, a predefined assembly, and/or any other information suitable for use with the methods and systems described herein. As described below, computing device 105 transforms the received input into a design of an air intake apparatus.

In the exemplary embodiment, input interface 130 is coupled to processor 115 and may include, for example, a keyboard, a pointing device, a mouse, a stylus, a touch sensitive panel (e.g., a touch pad or a touch screen), a gyroscope, an accelerometer, a position detector, and/or an audio input interface. A single component, such as a touch screen, may function as both a display device of presentation interface 120 and as input interface 130.

Computing device 105 may include a communication interface 135 coupled to processor 115. Communication interface 135 is coupled in communication with a remote device, such as another computing device 105. For example, communication interface 135 may include, without limitation, a wired network adapter, a wireless network adapter, and/or a mobile telecommunications adapter.

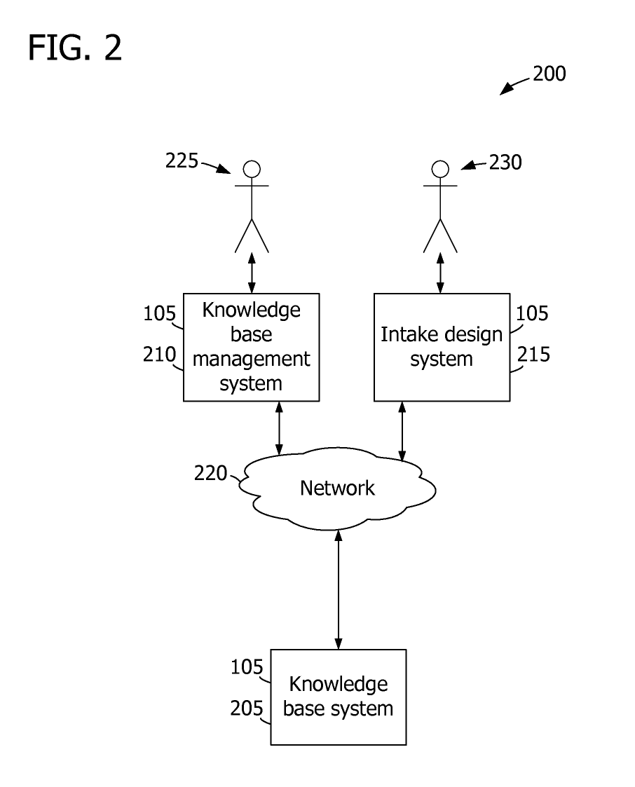

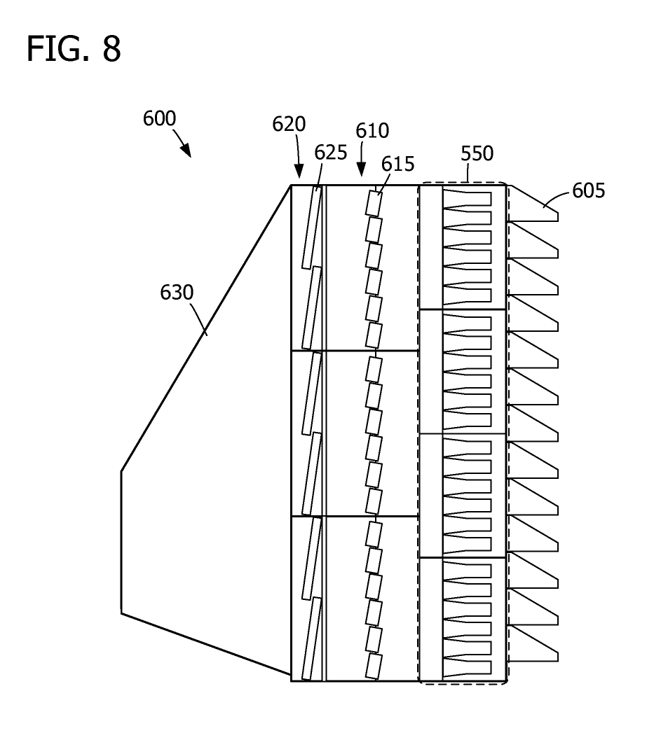

FIG. 2 is a block diagram of an exemplary design system 200 that may be used to design an air intake (e.g., as shown in FIG. 8). In the exemplary embodiment, system 200 includes a knowledge base system 205, a knowledge base management system 210, and an intake design system 215 coupled in communication via a network 220. Network 220 may include, without limitation, the Internet, a local area network (LAN), a wide area network (WAN), a wireless LAN (WLAN), a mesh network, and/or a virtual private network (VPN).

Knowledge base system 205, knowledge base management system 210, and intake design system 215 are computing devices 105 (shown in FIG. 1). In the exemplary embodiment, each computing device 105 is coupled to network 220 via communication interface 135. In an alternative embodiment, knowledge base system 205 is integrated with knowledge base management system 210 and/or with intake design system 215.

Knowledge base management system 210 interacts with a knowledge base administrator 225 (e.g., via input interface 130 and/or presentation interface 120). For example, knowledge base management system 210 may receive an association of a building standard, a structural feature, and/or a site attribute with one or more dimensional parameters, predefined structural members, predefined assemblies, and/or other physical components. Knowledge base management system 210 transmits the association to knowledge base system 205 via network 220. Knowledge base system 205 receives and stores the association (e.g., in memory device 110).

In some embodiments, knowledge base system 205 stores one or more dimensional attributes corresponding to a structural member, a structural feature, an assembly, and/or a physical component. For example, an access hatch may be associated with a width, a height, and/or a depth.

Intake design system 215 interacts with an intake designer 230 (e.g., via input interface 130 and/or presentation interface 120). In one embodiment, intake design system 215 creates a three-dimensional model of an air intake based at least in part on an indication of a building standard from intake designer 230, as described in more detail below.

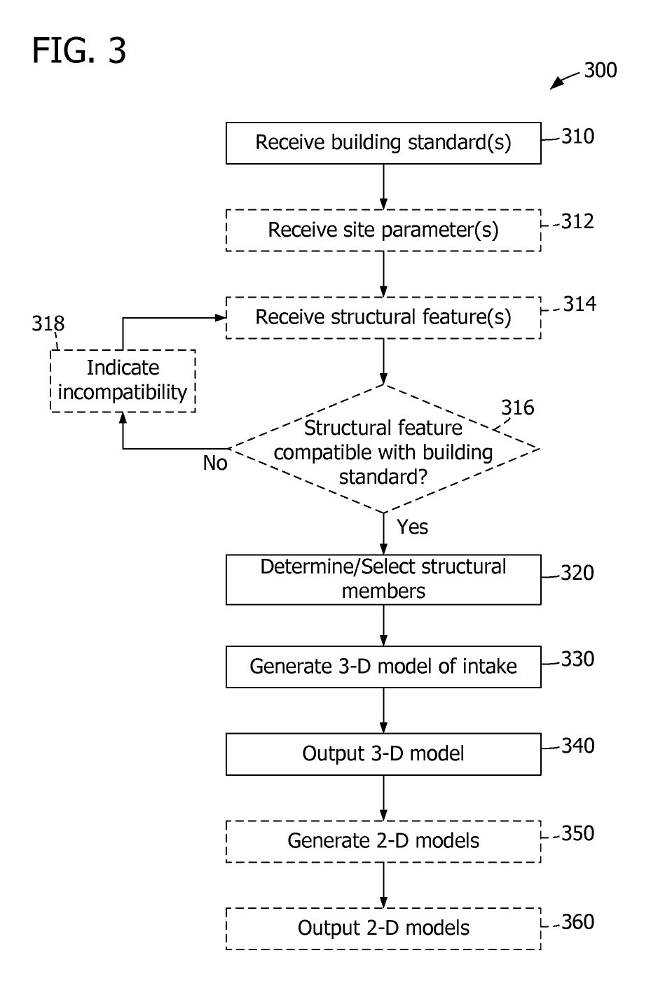

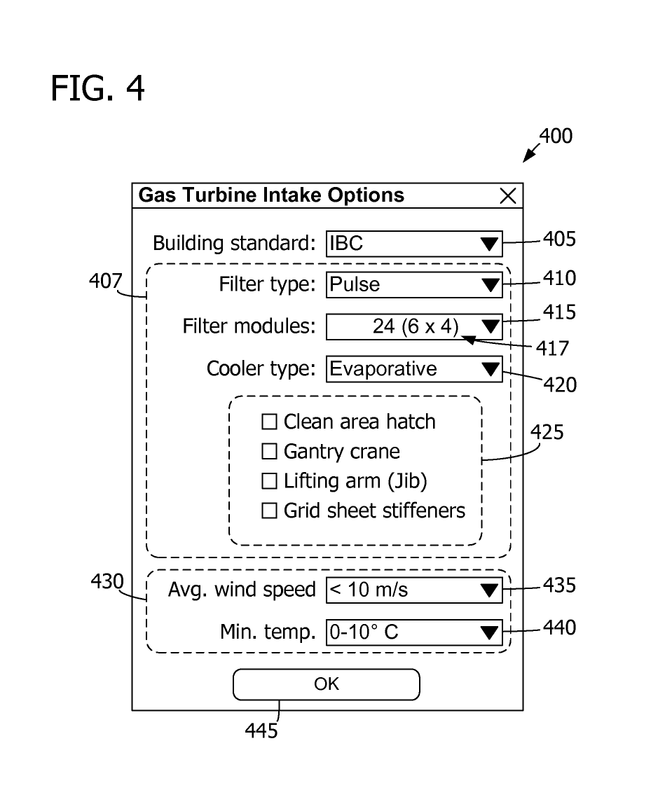

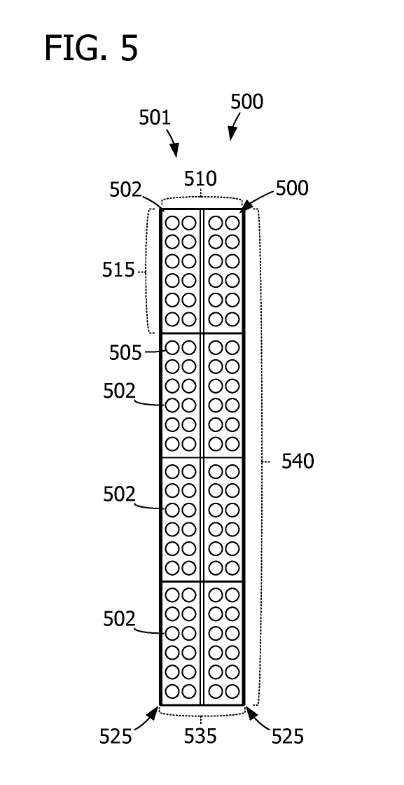

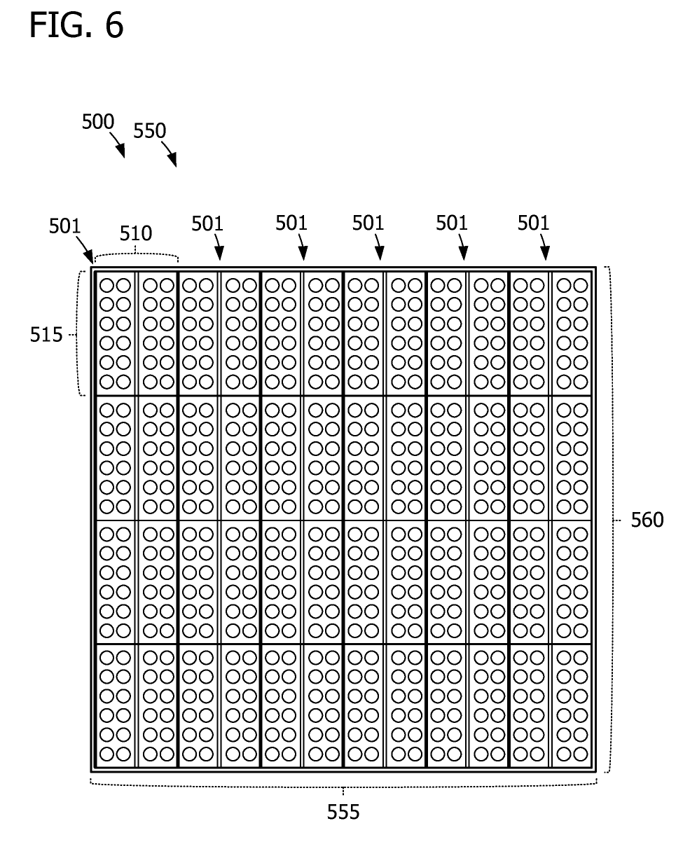

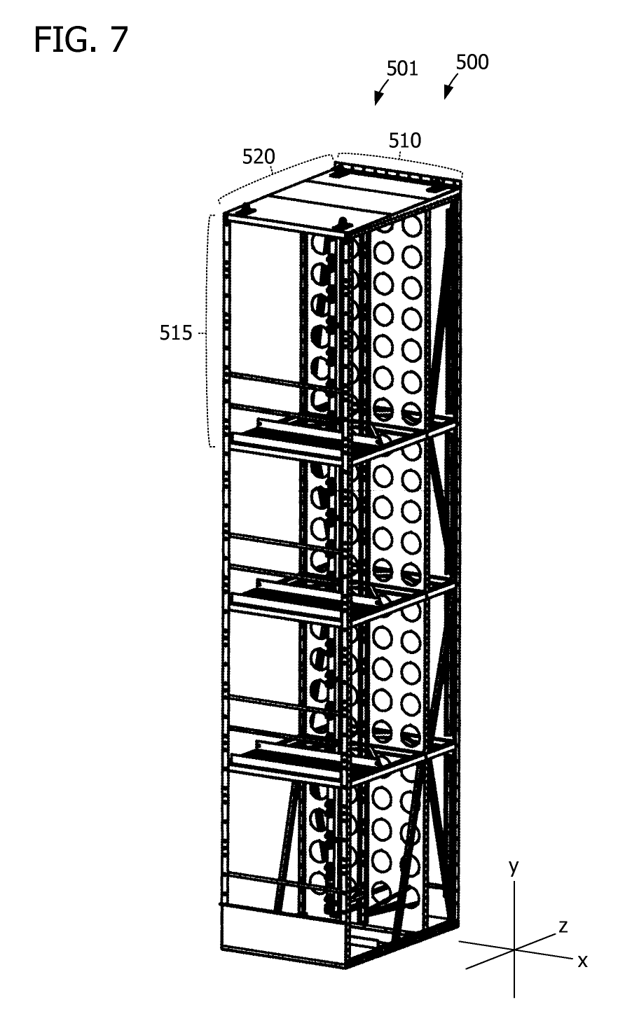

FIG. 3 is a flowchart of an exemplary method 300 for use in designing an air intake. Portions of method 300 may be performed, for example, by any one of or any combination of computing devices 105 in system 200. FIG. 4 is an exemplary graphical interface 400 that may be used with intake design system 215 and/or method 300. FIG. 5 is a schematic view of structural members 500, including an exemplary filter module stack 501 that includes a plurality of filter modules 502 designed using method 300. FIG. 6 is a schematic view of an exemplary filter module stack assembly 550 including filter module stack 501. FIG. 7 is an offset schematic view of filter module stack 501. FIG. 8 is a schematic view of an exemplary air intake 600 including filter module stack assembly 550.

In an exemplary embodiment, graphical interface 400 is presented to intake designer 230 via presentation interface 120, and graphical interface 400 is used to receive input from intake designer 230 via input interface 130, as described in more detail below.

In the exemplary embodiment, method 300 includes receiving 310, via input interface 130, an indication of a building standard that defines at least one structural requirement. For example, such a building standard may be indicated by a building standard selector 405, and the structural requirement may include, without limitation, a load requirement and/or a deflection requirement. For example, in FIG. 4, building standard selector 405 is shown with the International Building Code (IBC) selected. Building standard selector 405 may include other building standards, such as the Uniform Building Code (UBC) and/or any standard used to define structural requirements that are applicable to an air intake. In some embodiments, graphical interface 405 provides an indication of multiple building standards. For example, graphical interface 400 may include a plurality of building standard selectors 405.

An indication of one or more structural features may be received 314 via input interface 130. In the exemplary embodiment, graphical interface 400 includes a plurality of structural feature indicators 407, including, but not limited to, a filter type selector 410, a filter quantity selector 415, a cooler type selector 420, and a plurality of structural feature checkboxes 425. Filter type selector 410 includes a list of available filter types, such as a pulse filter, a static filter, and a pulse filter plus a static filter. Filter quantity selector 415 enables intake designer 230 to select a quantity of filters to include in an air intake.

In an exemplary embodiment, filter quantity selector 415 includes a list of available filter module quantities. More specifically, in the exemplary embodiment, an exemplary filter module 502 includes a plurality of filter holders 505 that each hold at least one filter (e.g., a pulse filter). For example, in FIG. 5, filter module 502 is configured to hold twenty-four filters. Alternatively, filter module 502 may be assembled from multiple physical components, such as, without limitation, a section of sheet metal (not shown) and one or more frame members (not shown). Filter module 502 has several dimensions (e.g., spatial dimensions) that are input into system 200 (e.g., into knowledge base system 205) as being associated with dimensional attributes. For example, in the exemplary embodiment, filter module 502 is associated with dimensional attributes including, but not limited to, a width 510, a height 515, and/or a depth 520.

Filter quantity selector 415 may organize filter module quantities in a column and row arrangement 417. For example, in the exemplary embodiment, filter quantity selector 415 arranges twenty-four filter modules 502 in six-by-four pattern 417. In another embodiment, twenty-four modules 502 are arranged in an eight-by-three arrangement (not shown). Moreover, in the alternative, filter quantity selector 415 may orient a quantity of filters and/or filter modules 502 in arrangements other than a column and row arrangement 417. In such an embodiment, intake design system 215 determines the quantity and orientation of filter modules 502 based on the quantity indicated by filter quantity selector 415. If multiple filter types are selected, graphical interface 400 may include a filter quantity selector 415 for each filter type.

In the exemplary embodiment, cooler type selector 420 includes a list of available intake cooler types. For example, such intake cooler types may include, without limitation, an evaporative cooler, a vapor compression cooler, and an evaporative cooler plus a vapor compression cooler. Structural feature checkboxes 425 include a collection of binary structural feature options for indicating whether one or more optional structural features are to be included in the air intake.

An indication of one or more site attributes may also be received 312 via input interface 130. For example, graphical interface 400 may include site attribute indicators 430. A site attribute indicator enables an intake designer 230 to enter and/or indicate a site attribute, such as, without limitation, a geographical attribute (e.g., an elevation), a geological attribute (e.g., a seismic activity and/or a terrain composition, such as bedrock or clay), a meteorological attribute (e.g., an expected minimum temperature and/or an average wind speed), and a site dimension. In the exemplary embodiment, graphical interface 400 includes an average wind speed indicator 435 and a minimum temperature indicator 440.

Graphical interface 400 also includes an acceptance button 445. In response to intake designer 230 selecting button 445, processor 115 determines 320 which structural members 500 and/or the number of each structural member 500 to be included. Such a determination is based at least in part on the indicated building standard from building standard indicator 405, the indicated structural features, if any, from structural feature indicators 407 and the indicated site attributes, if any, from site attribute indicators 430.

In some embodiments, knowledge base system 205 stores an association of one or more building standards, structural features, and/or site attributes with one or more dimensional parameters, predefined structural members, and/or predefined assemblies. In one embodiment, determining 320 the plurality of structural members 500 includes selecting at least one predefined structural member from knowledge base system 205 based at least in part on the applicable building standards. For example, the International Building Code (IBC) may be associated with a structural member having one load bearing capacity, and the Uniform Building Code (UBC) may be associated with a similar structural member having a different load bearing capacity. A structural member 500 may be selected based in addition on a structural feature and/or a site attribute. For example, a structural attribute, such as a gantry crane, may be associated with a structural member that has a higher load bearing capacity than a load bearing capacity of a corresponding structural member associated with the indicated building standard. Accordingly, the structural member having the higher load bearing capacity (i.e., the structural member associated with the gantry crane) may easily be selected.

In one embodiment, at least one dimensional parameter (e.g., a minimum width for an access passage) is selected from knowledge base system 205 based on the building standard, and/or a structural member may be selected from knowledge base system 205 based on the selected dimensional parameter and/or one or more dimensional attributes associated with the structural member 500. For example, an access hatch having a width greater than or equal to a minimum width for a means of egress from may be selected.

Furthermore, in some embodiments, a predefined assembly (e.g., filter module stack 501) may be selected from knowledge base system 205 based on at least one of the building standard, an indicated structural feature, and/or an indicated site attribute. For example, the building standard may be associated with the predefined assembly in knowledge base system 205, or the predefined assembly may be selected from knowledge base system 205 based on one or more dimensional attributes of the predefined assembly and one or more dimensional parameters associated with the building standard.

In the exemplary embodiment, one or more structural members 500 and/or predefined assemblies is selected based on an indicated structural feature. For example, if a six-by-four arrangement 417 of filter modules 502 is indicated in filter quantity selector 415, processor 115 may be programmed to select filter module 502 from knowledge base system 205 and to include twenty-four instances of filter module 502 in a model for an air intake.

In some embodiments, a structural member 500 and/or a predefined assembly is defined in knowledge base system 205 as having one or more variable dimensional attributes. For example, a length, a height, a depth, and/or a thickness of such a component may be defined as variable. Furthermore, permissible values (e.g., a plurality of discrete values and/or a continuous range of values) may be associated with a variable dimensional attribute. In such an embodiment, one or more dimensional attributes of a structural member and/or predefined assembly may be calculated based on an indicated structural feature and/or a dimensional parameter associated with a building standard. For example, the length of an access platform may be determined based on a quantity of filter module stacks 501, which may, in turn, be calculated based on a filter quantity and/or arrangement.

Such embodiments facilitate adapting standardized components to requirements of a specific site and/or air intake system. Accordingly, the effort of defining and maintaining variations of similar components that differ only in dimension may be avoided. Furthermore, defining one dimensional attribute (e.g., length) as variable and other dimensional attributes (e.g., height and width) as fixed or static facilitates adapting a component for such requirements while simplifying the design of other components, which may be defined based on an assumption that the fixed dimensional attributes will not vary. For example, a supporting structural member may be designed to be coupled to and/or to interface with a supported component based on a fixed width of the supported component, regardless of the length of the supported component.

Assemblies, such as filter module 502, may be combined into other assemblies. As shown in FIG. 6, filter module stack 501 includes four filter modules 502 oriented in a vertical arrangement. Filter module stack 501 may include other physical components, such as fasteners (not shown) for coupling filter modules 502 to each other and/or additional frame members 525. Filter module stack 501 is fabricated with dimensional attributes, including a width 535, a height 540, and/or a depth 520.

As shown in FIG. 7, in one embodiment, filter module stack assembly 550 includes six filter module stacks 501. Similar to filter module stack 501, filter module stack assembly 550 may include additional physical components, such as fasteners and/or additional frame members. Moreover, in the exemplary embodiment, filter module stack assembly 550 is fabricated and associated with dimensional attributes including a width 555, a height 560, and/or a depth 520. Assemblies such as filter module stack 501 and filter module stack assembly 550 may be stored in knowledge base system 205.

In some embodiments, processor 115 is programmed to select an optimal (e.g., requiring the fewest additional assemblies and/or additional components) predefined assembly that is associated with and/or that is appropriate for a building standard, a structural feature, and/or a site attribute. For example, processor 115 may be programmed to select an available filter module stack assembly 550 based at least partially on determining 320 that filter module stack 501 and filter module 502 would need to be combined with other components to create a six-by-four arrangement 417 as selected in filter quantity selector 415. In addition to, or in the alternative, the structural feature indicated by filter quantity selector 415 (i.e., the six-by-four arrangement 417 of filter modules) may be associated with filter module stack assembly 550 in knowledge base system 205, and filter module stack assembly 550 may be selected based on such an association. Such embodiments enable the reuse of larger, standardized assemblies.

In some embodiments, a structural member 500 and/or a predefined assembly is selected based on one or more site attributes. For example, a predefined assembly may be selected based on an average wind speed and/or an indication of moderate or severe seismic activity. Such site attributes may be associated with one or more structural members and/or predefined assemblies having a relatively high load bearing capacity.

A three-dimensional model (e.g., as depicted in FIG. 7) of an air intake is generated 330 by processor 115 based at least in part on the structural members 500 and/or the predefined assemblies determined and/or selected by processor 115. For example, the three-dimensional model may include the structural members 500 and the predefined assemblies. In an exemplary embodiment, the three-dimensional model of the air intake represents a design of at least a portion of an intake filter house.

The three-dimensional model is output 340 via a presentation interface 120. For example, the three-dimensional model may be displayed and/or printed 340 by a display device. In one embodiment, the three-dimensional model is stored in memory device 110 as a computer-aided design (CAD) file, and processor 115 is programmed to execute CAD software to output the three-dimensional model to intake designer 230 via presentation interface 120.

Outputting 340 the three-dimensional model may include displaying and/or printing 340 an offset or perspective view of one or more assemblies, such as shown in FIG. 7. In one embodiment, input interface 130 is configured to receive a view adjustment input from intake designer 230, and presentation interface 120 is configured to manipulate (e.g., rotate and/or tilt) the view of filter module stack 501 along one or more of an x-axis, a y-axis, and a z-axis.

In the exemplary embodiment, a plurality of structural members 500 are combined to generate 330 a three-dimensional model of air intake 600, as shown in FIG. 8. More specifically, FIG. 8 is a two-dimensional side view of air intake 600. Air intake 600 includes filter module stack assembly 550. Positioned upstream of filter module stack assembly 550 is a plurality of weather hoods 605. Positioned downstream of filter module stack assembly 550 is a static filter assembly 610 including a plurality of static filter holders 615 and an evaporative cooler assembly 620 including a plurality of evaporative cooling elements 625. Positioned downstream of evaporative cooler assembly is a transition unit 630. Like filter module stack assembly 550, air intake 600, weather hoods 605, static filter assembly 610, evaporative cooler assembly 620, and/or transition unit 630 may correspond to predefined assemblies stored in knowledge base system 205 and may be associated with dimensional attributes. In addition to, or alternatively, each assembly 600, 605, 550, 610, 620, 630 may be associated with one or more building standards, structural features, and/or site attributes within knowledge base system 205.

In some embodiments, a plurality of two-dimensional models and/or images is generated 350 by processor 115 based on the three-dimensional model. For example, the two-dimensional models may include schematic views of at least a portion of the air intake, as shown in FIGS. 5-8. Presentation interface 120 may be further configured to output 360 the two-dimensional models and/or images. The two-dimensional models may include a front view, a rear view, a side view, a top view, a bottom view, and/or an offset or perspective view of any portion of the air intake.

In one embodiment, the two-dimensional models include schematics indicating a composition and/or a construction of at least a portion of the intake filter house. Such schematics may include manufacturing diagrams, for example. The intake filter house, or a portion thereof, may be constructed based on the schematics. Such embodiments facilitate construction of an air intake using standardized assemblies that are automatically selected based on site requirements.

Some embodiments facilitate construction of an air intake in accordance with a plurality of building standards. For example, input device 130 may be configured to receive an indication of a plurality of building standards. Each building standard may be associated with one or more structural members 500, predefined assemblies, structural requirements, and/or dimensional parameters in knowledge base system 205. Structural members 500 and/or predefined assemblies are determined 320 based at least in part on the data associated with each indicated building standard. For example, where indicated building standards have corresponding structural requirements (e.g., a quantity of means of egress), processor 115 may be programmed to select a stricter structural requirement, a stricter dimensional parameter, and/or a larger structural member 500 and/or predefined assembly from the indicated building standards.

In some embodiments, method 300 includes determining 316 whether the indicated structural features are compatible with the indicated building standard and/or an indicated site parameter. For example, an indicated structural feature may specify the omission of a component that is optional according to some building standards. If the indicated building standard requires the component, processor 115 may be programmed to determine that the omission of the component is incompatible with the indicated building standard. When the indicated structural features are compatible the indicated building standard, method 300 proceeds as described above. When an indicated structural feature is incompatible with the indicated building standard, presentation interface 120 is configured to indicate 318 a feature incompatibility to intake designer 230. A new indication of structural features and/or a new indication of a building standard may be received 314 via input interface 130, and processor 115 is programmed to again determine 316 whether the indicated structural features are compatible with the indicated building standard.

Embodiments described herein facilitate automating the design of an air intake by selecting structural components from a knowledge base using input parameters such as, but not limited to, an applicable building standard, a desired quantity of filters, and/or one or more desired optional features. Moreover, providing a knowledge base with standardized components that are appropriate for such input parameters enables reuse of those standardized components and facilitates reducing the costs associated with custom fabrication.

The methods and systems described herein are not limited to the specific embodiments described herein. For example, components of each system and/or steps of each method may be used and/or practiced independently and separately from other components and/or steps described herein. In addition, each component and/or step may also be used and/or practiced with other apparatus and methods.

While the invention has been described in terms of various specific embodiments, those skilled in the art will recognize that the invention may be practiced with modification within the spirit and scope of the claims.

What is claimed is:

1. A system for use in designing an air intake apparatus, said system comprising:
an input interface configured to receive an indication of a building standard and an indication of a structural feature, wherein the building standard defines at least one structural requirement;
a processor coupled to said input interface and programmed to:
determine, based at least in part on the building standard, a number of structural members to be used in an air intake; and
generate a three-dimensional model of the air intake based at least in part on the structural members determined and the indicated structural feature; and
a presentation interface coupled to said processor and configured to output the three-dimensional model to a user.

2. A system according to claim 1, wherein said input interface is configured to receive an indication of a structural feature including at least one of an intake filter quantity, an intake filter type, and an intake cooler type.

3. A system according to claim 1, wherein said processor is programmed to generate the three-dimensional model of the air intake at least in part by generating a three-dimensional model of an intake filter house.

4. A system according to claim 1, further comprising a knowledge base system for associating the building standard with a plurality of dimensional parameters, said processor is further programmed to determine the number of structural members based on the dimensional parameters.

5. A system according to claim 1, further comprising a knowledge base system for associating the building standard with at least one predefined structural member, said processor is further programmed to determine the number of structural members at least in part by selecting the predefined structural member based on the building standard.

6. A system according to claim 1, further comprising a knowledge base system for associating a plurality of structural features with a plurality of predefined assemblies, said processor is further programmed to:
select the predefined assembly from the knowledge base system based at least in part on the indicated structural feature; and
include the selected predefined assembly in the three-dimensional model of the air intake.

7. A system according to claim 1, wherein said processor is further programmed to generate a plurality of two-dimensional models based on the three-dimensional model, and said presentation interface is configured to output the plurality of two-dimensional models.

8. A system according to claim 1, wherein:
said input interface is further configured to receive an indication of a site attribute indicating at least one of a geological attribute, a meteorological attribute, and a site dimension; and
said processor is programmed to generate the three-dimensional model based further on the site attribute.

9. A system according to claim 1, wherein said processor is further programmed to generate the three-dimensional model based on determining that the indicated structural feature is compatible with the building standard.

10. A system according to claim 1, wherein said processor is programmed to calculate a variable dimensional parameter of a structural member based on at least one of the building standard and the structural feature.

11. A method for use in designing an air intake apparatus, said method comprising:
receiving, via an input interface, an indication of at least one requirement, the at least one requirement including at least one of a load requirement, a deflection requirement, a dimensional attribute, and a ventilation requirement;
by a processor, determining, based at least in part on the at least one requirement, a number of structural members to be used in an air intake;
by the processor, generating a three-dimensional model of the air intake, the three-dimensional model including the structural members determined; and
outputting the three-dimensional model via a presentation interface.

12. A method according to claim 11, wherein generating the three-dimensional model of the air intake comprises generating a three-dimensional model of an intake filter house.

13. A method according to claim 11, wherein generating the three-dimensional model of the air intake comprises generating a three-dimensional model of a transition unit for routing air from a plurality of filters to a combustion engine.

14. A method according to claim 11, wherein generating the three-dimensional model of the air intake comprises generating a three-dimensional model of an evaporative cooler.

15. A method according to claim 11, wherein determining the number of structural members based at least in part on the at least one requirement comprises selecting a predefined structural member based at least in part on one or more dimensional parameters associated with a building standard and one or more dimensional attributes associated with the predefined structural member.

16. A method according to claim 11, wherein receiving the indication of the at least one requirement comprises receiving an indication of a building standard, the method further comprising:
associating the building standard with at least one predefined structural member in a knowledge base system,
wherein determining the number of structural members based at least in part on the building standard comprises selecting the at least one predefined structural member from the knowledge base system based on the building standard.

17. A method according to claim 11, further comprising:
receiving at least one site attribute including at least one of a geological attribute, a meteorological attribute, and a site dimension; and
determining the plurality of structural members based further on the at least one site attribute.

18. A method according to claim 11, further comprising receiving an indication of at least one structural feature related to the air intake; and
determining the plurality of structural members based further on the indicated structural feature.

19. A method according to claim 18, wherein receiving an indication of at least one structural feature comprises receiving an indication of a quantity of intake filters, an intake filter type, and an intake cooler type.

20. A method according to claim 11, further comprising:
receiving an indication of a first building standard and a second building standard; and
determining the plurality of structural members based at least in part on the first building standard and the second building standard.
